(19) United States
(12) Patent Application Publication
(10) Pub. No.: US 2020/0128042 A1
(43) Pub. Date: Apr. 23, 2020

(54) COMMUNICATION METHOD AND APPARATUS FOR AN INDUSTRIAL CONTROL SYSTEM

(71) Applicant: Singapore University of Technology and Design, Singapore (SG)

(72) Inventors: Martin OCHOA, Singapore (SG); Nils Ole TIPPENHAUER, Singapore (SG); John Henry CASTELLANOS, Singapore (SG); Daniele ANTONIOLI, Singapore (SG)

(21) Appl. No.: 16/626,843

(22) PCT Filed: Jul. 4, 2018
(86) PCT No.: PCT/SG2018/050326

§ 371 Date: Dec. 26, 2019

(30) Foreign Application Priority Data
Jul. 5, 2017 (SG) 10201705539X

(51) Int. Cl. H04L 29/06; H04L 9/32; H04L 29/08; G06F 21/72; G06F 21/64; G06F 21/55; G05B 19/048

(52) U.S. Cl. CPC H04L 63/1466; H04L 63/1416; H04L 63/126; H04L 9/3247; G05B 19/048; G06F 21/72; G06F 21/64; G06F 21/55; H04L 67/12

(57) ABSTRACT

A communication method 100 for an industrial control system (ICS) is disclosed. The method 100 includes receiving network packets that are sent to an address in the ICS. The network packets carry critical payloads 1000 and non-critical payloads 1100. The method 100 further includes selectively capturing a critical network packet 1000. The critical network packet 1000 is identified based on a predefined list of critical payloads capable of controlling a physical state of the ICS. The method 100 further includes generating a signature Sigk {p} 1300 from the critical network packet 1000 using a signing algorithm and transmitting a combined network packet 1200 that includes the critical network packet 1000 and the signature to the address. The method 100 further includes receiving the combined network packet 1200 at the address, and verifying the integrity of the critical network packet 1000 by authenticating the signature 1300 using a verification algorithm.

### TECHNICAL FIELD

The present disclosure relates to communication methods and apparatuses for an industrial control system (ICS). More particularly, it relates to IT security measures that interface with ICS communication.

### BACKGROUND

Industrial Control Systems (ICS) are a subset of Cyber-Physical Systems that monitor industrial infrastructures such as Water Treatment systems, nuclear power plants, smart grids, and electric power distribution systems. ICS commonly rely on unencrypted and unauthenticated communication between industrial devices such as Programmable Logic Controllers (PLC), Human-Machine-Interfaces (HMI), sensors, and actuators.

In the past, critical infrastructure control networks were isolated from the office and corporate networks, and thus malware and other attacks did not pose a realistic threat to such control networks. However, nowadays with the increased connectivity to general IT infrastructures such as a LAN, and the Internet itself, attacks such as the well-known Man-in-the-Middle between ICS devices are more realistic. For ICS communications, message integrity is paramount, while confidentiality of messages exchanged is less important. In particular, if an attacker can alter the values of the sensors or the commands being sent to the actuators, he could effectively alter the control of the ICS and potentially cause the malfunctioning of the physical system. Securing a safety-critical ICS against malicious attackers may therefore be crucial to prevent system failure which could have catastrophic results.

An ICS may be vulnerable both to cyber-attacks and physical attacks. Cyber-attacks stem from the inclusion of networking capabilities within the ICS which may be connected to the Internet. Physical attacks depend mostly on the type of ICS, and usually require physical access to the industrial system. Unfortunately, a combination of cyber and physical attacks can result in severe damage to the system even without physical access to the system.

Compared to standard corporate networks, an ICS network usually includes a wider range of devices. In addition, the ICS is usually connected to older legacy hardware, as well as newer hardware. The ICS therefore has to manage software with different capabilities and programming interfaces. In addition, a traditional ICS network often has a long life time (e.g. twenty years).

Invariably, many of its components are unlikely to change or be upgraded over the years. Legacy hardware has lower computational capabilities than newer hardware which results in a lower tolerance to computation overhead. The use of cryptographic schemes in ICS networks is therefore hindered by their long lifetime, compatibility issues, low processing power of the embedded devices, and real-time requirements in the communication

One method in prior art analysed different attacks on PLCs and several protection techniques for ICS and proposed a public key based authentication protocol. However, the method degraded the performance of the system on which the protocol was applied and no solution was provided.

Given the real-time constraints of ICS networks, securing the ICS networks and implementing cryptographic operations can be challenging. Therefore, it is desirable to provide communication methods that can address the challenges mentioned and in particular, enable IT security measures to be interfaced with ICS, and/or to provide the public with a useful choice.

### SUMMARY

Various aspects of the present disclosure are described here. It is intended that a general overview of the present disclosure is provided and this, by no means, delineate the scope of the invention.

According to a first aspect, there is provided a communication method for an industrial control system (ICS). The communication method includes the step of receiving network packets that are being sent to an address in the ICS. The network packets carry critical and non-critical payloads. The communication method further includes selectively capturing a critical network packet. The critical network packet is identified based on a predefined list of critical payloads capable of controlling a physical state of the ICS. The communication method further includes generating a signature from the critical network packet using a signing algorithm and transmitting a combined network packet that includes the critical network packet and the signature to the address.

As a result, the described embodiment provides a way to authenticate communication in the ICS while being computationally efficient enough to allow resource-constrained devices to sign and verify packets fast enough to be implemented in the ICS.

The critical payloads may be generated from system services that deal with data read from sensors or actuators, and data written to actuators or registers of devices in the ICS.

The system services may include Read Data, Write Data, and Read Tag Fragmented Data.

The communication method may further include embedding the signature as an additional payload in the combined network packet.

The communication method may further include embedding a timestamp or a counter to the combined network packet.

Generating the signature may be performed at a signing rate at least equal to a capture rate at which the critical network packet is being selectively captured.

The signing algorithm may be a symmetric or an asymmetric signature algorithm.

According to a second aspect, there is provided a second communication method for an industrial control system (ICS). The method includes the step of receiving a combined network packet which includes a critical network packet and a signature. The critical network packet is selectively captured from network packets carrying critical and non-critical payloads that are sent from an address in the ICS. The critical network packet is identified based on a predefined list of critical payloads capable of controlling a physical state of the ICS. The signature is generated from the critical network packet using a signing algorithm before being transmitted. The communication method further includes verifying integrity of the critical network packet by authenticating the signature using a verification algorithm.

Verifying the integrity of the critical network packet may be performed at a verification rate at least equal to a receiving rate at which the combined network packet is being received.

Where the signing algorithm is a symmetric signature algorithm, the communication method may further include authenticating the signature by generating a verification signature from the critical network packet using the verification algorithm, and comparing the verification signature to the signature received for a match.

Alternatively, where the signing algorithm is an asymmetric signature algorithm, the communication may instead include authenticating the signature by generating an output associated with the critical network packet from the signature received using the verification algorithm, and comparing the output to the critical network packet for a match.

The communication method may further include sounding an alarm when there is a mismatch.

According to a third aspect, there is provided a third communication method for an industrial control system (ICS). The third communication method incorporates the first and second communication methods exemplified in the first and second aspects respectively.

According to a fourth aspect, there is provided a fourth communication method for an industrial control system (ICS). The communication method includes the step of receiving network packets that are being sent to an address in the ICS. The network packets carry respective payloads. The communication method further includes accumulating the network packets in a signature queue to obtain an aggregate signature packet. The aggregated signature packet includes an aggregate of payloads associated with the respective network packets. The communication method further includes generating an aggregated signature from the aggregated signature packet using a signing algorithm, and transmitting the aggregated signature to the address.

Advantageously, the described embodiment, improves signing and verification rates per packet while at the same time achieving good reaction times to attacks.

The communication method may further include transmitting the network packets unsigned to the address.

The communication method may further include accumulating the network packets for a time interval, T. The time interval, T is derived based on a reaction time to attacks and a signing time for generating the aggregated signature.

The communication method may further include transmitting the aggregated signature with sequence numbers of a first and a last element of the signature queue to the address.

According to a fifth aspect, there is provided a fifth communication method for an industrial control system (ICS). The communication method includes the steps of receiving network packets carrying respective payloads, and accumulating the network packets in a verification queue to obtain an aggregated verification packet. The aggregated verification packet includes an aggregate of payloads associated with the respective network packets. The communication method further includes receiving an aggregated signature generated from an aggregated signature packet using a signing algorithm. The aggregated signature is obtained by accumulating the network packets in a signature queue. The communication method further includes verifying integrity of the network packets by authenticating the aggregated signature using a verification algorithm.

The communication method may further include transmitting the network packets unverified to the address in the ICS.

Where the signing algorithm is a symmetric signature algorithm, the communication method may further include authenticating the aggregated signature by generating an aggregated verification signature from the aggregated verification packet using the verification algorithm, and comparing the aggregated verification signature to the aggregated signature received for a match.

Alternatively, where the signing algorithm is an asymmetric signature algorithm, the communication method may instead include authenticating the aggregated signature by generating an output associated with the aggregated signature packet from the aggregated signature received using the verification algorithm, and comparing the output to the aggregated verification packet for a match.

The communication method may further include sounding an alarm when there is a mismatch.

The respective payloads may include critical and non-critical payloads. The communication method may further include selectively capturing critical network packets. The critical network packets are identified based on a predefined list of critical payloads capable of controlling a physical state of the ICS.

The number of network packets accumulated may be at least 50.

The ICS may be a water treatment system, a nuclear power plant, a smart grid, or an electric power distribution system.

Accordingly to a sixth aspect, there is provided a sixth communication method for an industrial control system (ICS). The sixth communication method incorporates the fourth and fifth communication methods exemplified in the fourth and fifth aspects respectively.

Accordingly to a seventh aspect, there is provided a signature module for an Industrial Control System (ICS). The signature module includes a signature receiver arranged to receive network packets that are being sent to an address in the ICS. The network packets carry critical and non-critical payloads. The signature module further includes a signature processor arranged to selectively capture a critical network packet. The critical network packet is identified based on a predefined list of critical payloads capable of controlling a physical state of the ICS. The signature processor is further arranged to generate a signature from the critical network packet using a signing algorithm. The signature module further includes a signature transmitter arranged to transmit a combined network packet comprising the critical network packet and the signature to the address.

According to an eighth aspect, there is provided a verification module for an Industrial Control System (ICS). The verification module includes a verification receiver arranged to receive a combined network packet comprising a critical network packet and a signature. The critical network packet is selectively captured from network packets carrying critical and non-critical payloads that are sent from an address in the ICS. The critical network packet is identified based on a predefined list of critical payloads capable of controlling a physical state of the ICS. The signature is generated from the critical network packet using a signing algorithm before being transmitted. The verification module further includes a verification processor arranged to verify the integrity of the critical network packet by authenticating the signature using a verification algorithm.

According to a ninth aspect, there is provided a communication apparatus for an Industrial Control System (ICS). The communication apparatus includes the signature module exemplified in the seventh aspect and the verification module exemplified in the eighth aspect.

According to a tenth aspect, there is provided a signature module for an Industrial Control System (ICS). The signature module includes a signature receiver arranged to receive network packets that are being sent to an address in the ICS. The network packets carry respective payloads. The signature module further includes a signature processor arranged to accumulate the network packets in a signature queue to obtain an aggregated signature packet. The aggregated signature packet includes an aggregate of payloads associated with the respective network packets. The signature processor is further arranged to generate an aggregated signature from the aggregated signature packet using a signing algorithm. The signature module further includes a signature transmitter arranged to transmit the aggregated signature to the address.

According to an eleventh aspect, there is provided a verification module for an Industrial Control System (ICS). The verification module includes a verification receiver arranged to receive network packets carrying respective payloads and to receive an aggregated signature generated from an aggregated signature packet using a signing algorithm. The aggregated signature packet is obtained by accumulating the network packets in a signature queue. The verification module further includes a verification processor arranged to accumulate the network packets in a verification queue to obtain an aggregated verification packet. The aggregated verification packet includes an aggregate of payloads associated with the respective network packets. The verification processor is further arranged to verify the integrity of the network packets by authenticating the aggregated signature using a verification algorithm.

According to a twelfth aspect, there is provided a communication apparatus for an Industrial Control System (ICS). The communication apparatus includes the signature module exemplified in the tenth aspect and the verification module exemplified in the eleventh aspect.

In any of the above embodiments, verifying the integrity of the network packets may also include verifying if the network packet or packets have been manipulated.

### BRIEF DESCRIPTION OF FIGURES

FIG. 1 is a timing diagram of an exemplary communication method for a communication system in an ICS.

FIG. 2 is a flow diagram showing the exemplary communication method of FIG. 1 from the perspective of a signature module in the ICS.

FIG. 3 is a flow diagram showing the exemplary communication method of FIG. 1 from the perspective of a verification module in the ICS.

FIG. 4 is a graph comparing the performance of the exemplary communication method of FIG. 1 against Transport Layer Security (TLS).

FIG. 5 is a timing diagram of an alternative communication method for a communication system in an ICS which builds on the exemplary communication method of FIG. 1.

FIG. 6 is a flow diagram for the alternative communication method of FIG. 5 from the perspective of a signature module in the ICS.

FIG. 7 is a flow diagram for the alternative communication method of FIG. 5 from the perspective of a verification module in the ICS.

FIG. 8 is a graph comparing the performance of the alternative communication method of FIG. 5 against Transport Layer Security (TLS).

FIG. 9 is a diagram of an exemplary Water Treatment Testbed network architecture on which the communication methods of FIGS. 1 and 5 are evaluated.

FIG. 10 is a graph comparing the performance of the alternative communication method of FIG. 5 implementing both symmetric (HMAC) and asymmetric (ECDSA) algorithms on different hardware.

### DETAILED DESCRIPTION

One or more embodiments of the present disclosure will now be described with reference to the figures. It should be specified that the use of the term “embodiment” in various parts of the specification does not necessarily refer to the same embodiment. Features disclosed in one embodiment may not be present in other embodiments, nor should they be understood as being precluded from other embodiments merely from the absence of the features from those embodiments. Various features described may be present in some embodiments and not in others.

Additionally, figures are there to aid in the description of the particular embodiments. The following description contains specific examples for illustration. The person skilled in the art would appreciate that variations and alterations to the specific examples are possible and within the scope of the present disclosure. The figures and the following description should not take away from the generality of the preceding summary.

Traffic Authentication for ICS: SPA Protocol

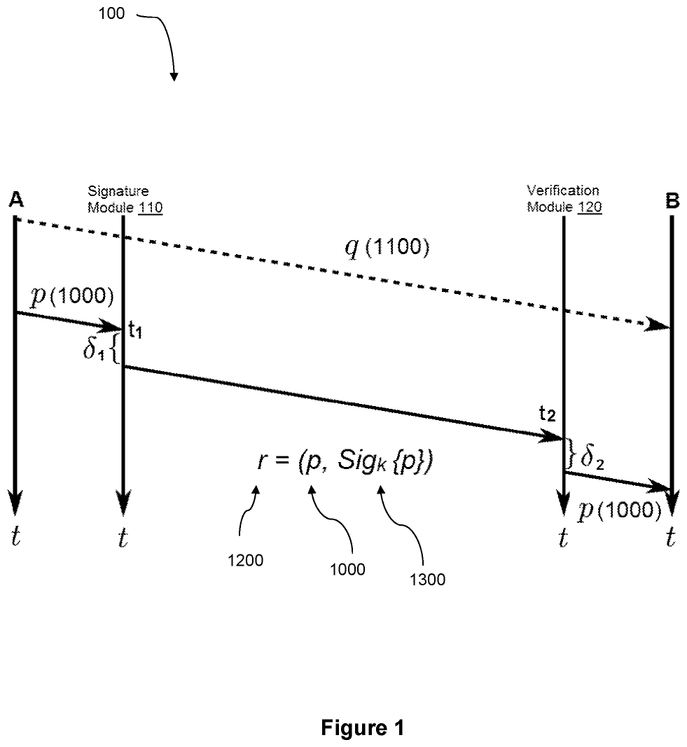

FIG. 1 is a timing diagram for an exemplary communication method 100 being implemented in an industrial control system. In the communication method 100, network packets are being communicated from a node A to a node B in the ICS.

The network packets carry both critical payloads 1000 and non-critical payloads 1100. The concept of critical payloads 1000 will now be explained in the following section.

Identification of Critical Payloads

The premise of identifying critical payloads 1000 is that not all packets being transmitted by nodes in the ICS need to be authenticated. It is appreciated that some packets are less important than others as their manipulation do not pose a threat to the ICS. As such, by identifying which network packets are carrying critical payloads 1000, those critical network packets can be selectively authenticated.

The integrity of messages exchanged in an ICS is protected in different layers of the Opens System Interconnection (OSI) network stack. Critical data/payload 1000 from the pool of CIP services observed in the traffic is captured. In particular, protection is required for data/payloads that can affect the normal operation of the control of physical processes in the ICS. Data that has been identified as such is labeled as critical payloads 1000. For example, data read from sensors are considered critical payloads 1000 as such data can modify the state of a physical process of the ICS. Similarly, data written to actuators or registers are considered critical payloads 1000 as such data can directly modify actuator functionality and affect the performance of the whole process in the ICS. In the case of ENIP-CIP, the identified critical services include Read Data (Service 0x4C), Write Data (Service 0x4D), and Read Tag Fragmented Data (Service 0x52). The details are discussed under Evaluation section below: Evaluation. Once identified, the identities of the critical payloads 1000 are placed in a predefined list. Critical network packets that carry critical payloads 1000 are then identified based on the predefined list.

Referring back to FIG. 1, a signature module 110 receives the network packets carrying both critical payloads 1000 and non-critical payloads 1100. However, only network packets that carry critical payloads 1000 are selectively captured at the signature module 110 while network packets that carry non-critical payloads 1100 are simply forwarded through the communication network to node B.

The signature module 110 may be internal for a high end ICS device and only firmware modification is needed, or it can also be provided as an external module for low-end ICS devices in order for the low end ICS device to tap into the ICS network.

At time t₁, the signature module 110 generates a signature Sigₖ{p} 1300 of the captured critical network packet 1000, and generates a new combined network packet 1200 [r=(p, Sigₖ {p})] which comprises both the signature 1300 and the critical network packet 1000. Calculating the signature 1300 necessarily incurs a delay δ₁ as shown in the timing diagram, and the combined network packet 1200 is transmitted at time t₁+δ₁.

At t₂, a verification module 120 receives the combined network packet 1200. Similar to the signature module 110, the verification module 120 may be internal for a high end ICS device and only firmware modification is needed, or it can also be provided as an external module for low-end ICS devices in order for the low end ICS device to tap into the ICS network.

A verification process then confirms integrity of the critical network packet 1000 (such as whether the critical network packet 1000 has been manipulated) by authenticating the signature 1300. This is done by using an inverse function VerK (where K=k for a symmetric signature algorithm or a corresponding public key for an asymmetric signature algorithm) available to the verification module 120. The verification process necessarily incurs a delay δ₂ as shown in the timing diagram, and the critical network packet 1000 is only forwarded to node B at time t₂+δ₂.

It should be noted that ICS operate under strict real-time operation conditions with maximal critical response time, high availability requirement, and low tolerance to high delay or jitter conditions.

Importantly, since only critical network packets 1000 are selectively captured and signed, the signature and verification processes and delays are correspondingly reduced. It should be noted that ‘signed’ or ‘sign’ refers to the process of generating a signature 1300 using a pre-shared key for the case of symmetric key cryptography or, a signature 1300 using the counterpart's public key for the asymmetric case.

Advantageously, the communication method 100 is computationally efficient enough to allow resource-constrained devices (such as PLCs) to sign and verify packets fast enough. In particular, communication method 100 is able to handle high volume traffic loads, without introducing high queuing, and processing delay.

It should also be noted that in order to be compliant with the real-time requirements of a given system, it is essential to authenticate/verify packets at least as fast as a rate at which the packets are being captured/received at the signature module 110 and verification module 120 respectively.

To give an example, the number of packets g(Δ) being generated or captured at the signature module 110 in a time interval ‘Δ’ is 1000 packets per second while the number of packets s(Δ) being signed at the signature module 110 (usually dependent on processing speed) in a time interval ‘Δ’ is 300 packets per second. In this example, the signature module 110 cannot sign as fast as the packets are being generated/captured resulting in a backlog of 700 packets per second which could result in delays in transmitting critical instructions. For an ICS which has low tolerance for high delay, this is undesirable. As such, it is clear that ‘g’≤‘s’ must be true. The same reasoning applies to the number of packets received r(Δ) at the verification module 120 and the number of packets being verified v(Δ) within a time interval ‘Δ’. ‘r’≥‘v’ must be true. The following section describes this in greater detail.

Real-Time Requirements and Backlogs

The delay produced by the signature module 110 can be represented as a queue of packets pending to be signed after a time interval A: Q_{Δ}^{S}=g(Δ)−s(Δ).

For the sake of readability, the definition of Q_{Δ}^{S} assumes an empty queue at the beginning of the time interval A. Otherwise, the queue should be defined as Q_{Δt+1}^{S}=g(Δ)−s(Δ)+Q_{Δt}^{S} but this would complicate the remainder of the section without any relevant added value. To avoid an avalanche effect on the packet queue Q_{Δ}^{S}, the queue must remain below a certain constant threshold C: ∀A. Q_{Δ}^{S}<0. In particular, since ‘Δ’ is arbitrary, for all practical purposes C≈0 (i.e., VA. Q_{Δ}^{S}<0) and thus: ∀Δ. g(Δ)<s(Δ).

A similar reasoning is applied to the constraints of the verification algorithm. If r(Δ) is the number of expected packets in a time interval ‘Δ’, then the number ‘v’ of verified packets in this interval must be v(Δ, cpu, alg)>r(Δ) to avoid backlogs of the verification queue Q_{Δ}^{V}.

However, s(Δ) depends not only on the time but also on the algorithm used, the CPU capacity, and the size of the packets. Similarly, in a fraction of time ‘Δ’, the device will produce not only packets at different rates, but will also nondeterministically produce packets of different sizes. To simplify the analysis, and without loss of generality, ‘Δ’ is set to 1 second, and s(cpu, alg) to the rate at which packets of a certain constant expected size can be signed using a certain ‘cpu’ and a given signature algorithm ‘alg’. When it is clear from the context, ‘s’, ‘v, g’ and ‘r’ will be used to abbreviate the rates per second of the signing, verification, outgoing(or generated) and incoming packets respectively.

Parallel Versus Sequential Signature

In computing the overheads of the proposed protocol, an architecture is assumed where network communications are handled by dedicated hardware. This avoids sharing the main device CPU (such as the main PLC computing unit), which is busy computing other control and communication related tasks. In practice this is usually the case, since communications are often handled by a dedicated network module. If a parallel implementation of the protocol is considered, where the signature and verification components have at least a single core each, then there will effectively be two queues, Q_{Δ}^{S} and Q_{Δ}^{V}. Otherwise, if hardware constraints impose a sequential implementation of the protocol, an incoming packet that needs to be verified has to potentially wait until an outgoing packet is signed; and vice versa, an outgoing packet has to wait until a verification is finished. Thus there is the constraint: ∀A. Q_{Δ}^{S}<C∧∀Δ. Q_{Δ}^{V}<C′ which can be simplified by considering a simple queue Q_{Δ}=Q_{Δ}^{S}∪Q_{Δ}^{V}=(g(Δ)−s(Δ))+(r(Δ)−v(Δ))<C+C′. As discussed above, C+C′≈0 compared to the number of packets received in an arbitrarily big ‘Δ’, and thus: (g(Δ)+r(Δ))<(s(Δ)+v(Δ)) In other words, the rate of signature and verification in a time interval has to be faster than the amount of packets sent and received in that same time interval.

Referring back to FIG. 1, while the communication method 100 is described with reference to the communication system as a whole, the communication method 100 can also be viewed from the perspective of two separate modules: the signature module 110 and the verification module 120.

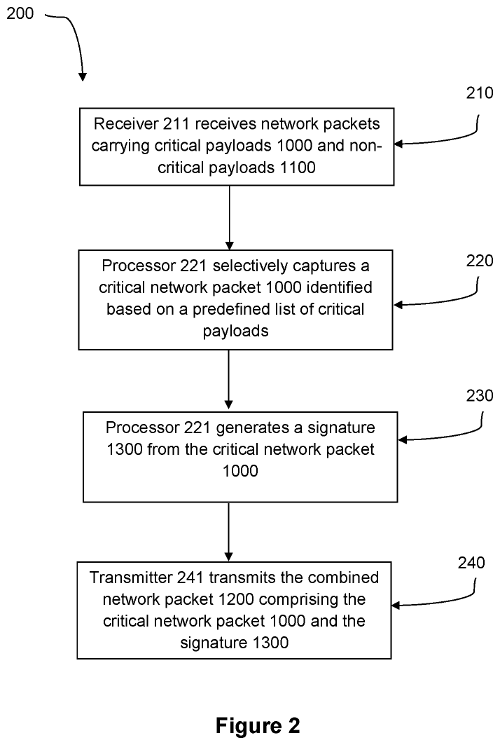

FIG. 2 is a flow diagram illustrating an exemplary communication method 200 from the perspective of the signature module 110.

At a step 210, a receiver 211 of the signature module 110 receives network packets that are being sent to an address in the ICS. The network packets carry both critical payloads 1000 and non-critical payloads 1100.

At a step 220, a processor 221 of the signature module 110 identifies network packets that are carrying critical payloads 1000 and selectively captures them. The critical network packets are identified based on a predefined list of critical payloads 1000 capable of controlling a physical state of the industrial control system.

At a step 230, the signature processor 221 generates a signature 1300 from the critical network packets 1000 using a signing algorithm.

The signing algorithm can be either a symmetric or an asymmetric signature algorithm. Notably, asymmetric signature algorithms provide more robust protection but tend to incur greater computational overhead.

At a step 240, a transmitter 241 of the signature module 110 then sends a combined network packet 1200 which includes the critical network packet 1000 and the signature 1300 to the intended address in the ICS.

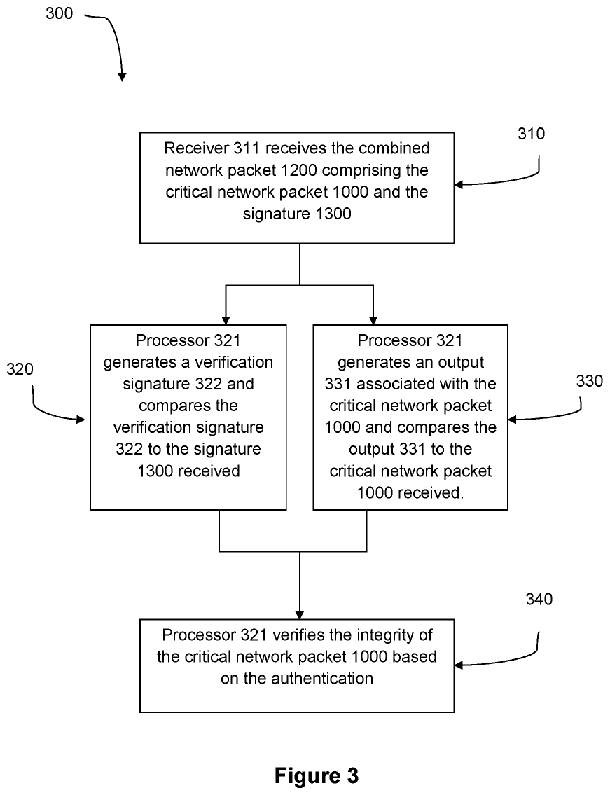

FIG. 3 is a flow diagram showing the communication method 300 from the perspective of the verification module 120.

At a step 310, a receiver 311 of the verification module 120 receives the combined network packet 1200 which includes the critical network packet 1000 and the signature 1300.

At a step 320 or 330, a processor 321 of the verification module 120 authenticates the signature 1300 to verify the integrity of the critical network packet 1000. The way that the signature 1300 is authenticated depends on the signature algorithm that was used to generate the signature 1300. For symmetric signature algorithm, at step 320, a verification signature is computed/generated from the critical network packet 1000 and compared to the signature 1300 that was received. For asymmetric signature algorithm, at step 330, an output related to the critical network packet 1000 is generated from the signature 1300 received and compared to the critical network packet 1000 received. In particular, the output is a hash (summary) of the critical network packet that was sent from the signature module 110.

At a step 340, the processor 321 verifies the integrity of the critical network packet 1000 based on the results of the previous step. For step 320, the critical network packet 1000 has not been manipulated if the verification signature matches the signature 1300 that was received. For step 330, the critical network packet 1000 received has not been manipulated if the output matches the hash of the critical network packet 1000 received at the verification module 120.

If there is a mismatch, the verification processor 321 raises an alarm to alert the system/user of an attack.

Application to ENIP-CIP

For simplicity, communication methods 100, 200, 300 will collectively be termed Selective Packet Authentication (SPA) hereinafter. An application of the SPA protocol to Common Industrial Protocol (CIP) traffic will now be discussed.

A critical ENIP packet 1000 moving from A to B carries a SPA payload which is given by the tuple=(payload, ENIPsequencenr, ENIPsessionid). The ENIP session ID is a randomly generated 32-bit integer to identify the ENIP session or packet. The ENIP session ID acts as a counter or timestamp to prevent replay attacks. Therefore, if an active adversary replays the message in a future ENIP session, the application layer will check the nonce and mark it as invalid.

When replacing a critical network packet 1000 with a combined network packet 1200 in the network, the length of the critical network packet 1000 that is signed will be increased. The packet extension must therefore conform to the ENIP standard. The structure is defined as follows: Type ID: 0x00c1. Length: size of the signature 1300 specified in Bytes. Data: the signature 1300.

The device receiving the combined network packet 1200 i.e. verification module 120 will search for the Type ID 0x00c1, verify the content of the payload as described in the preceding paragraphs, and then remove the signature 1300. In case of a mismatch, [p≠VerK {Sigk {p}}], the device will raise an alarm.

Ad-Hoc Protocols Versus Transport Layer Security (TLS)

The present disclosure focuses on ad-hoc protocols at the application layer, rather than on using TLS. This is firstly because TLS would sign every packet in a ENIP connection while the SPA protocol would only sign and verify a comparatively small amount of those and ignore packets such as TCP handshake, EtherNet/IP communication control messages and CIP non critical service messages. Integrity attacks on TCP handshake and ACK messages can in turn be detected by orthogonal methods. Secondly, by using the extension capabilities of ENIP, the present disclosure achieves backwards compatibility with devices that do not support message authentication. Such a feature would not be achievable using TLS.

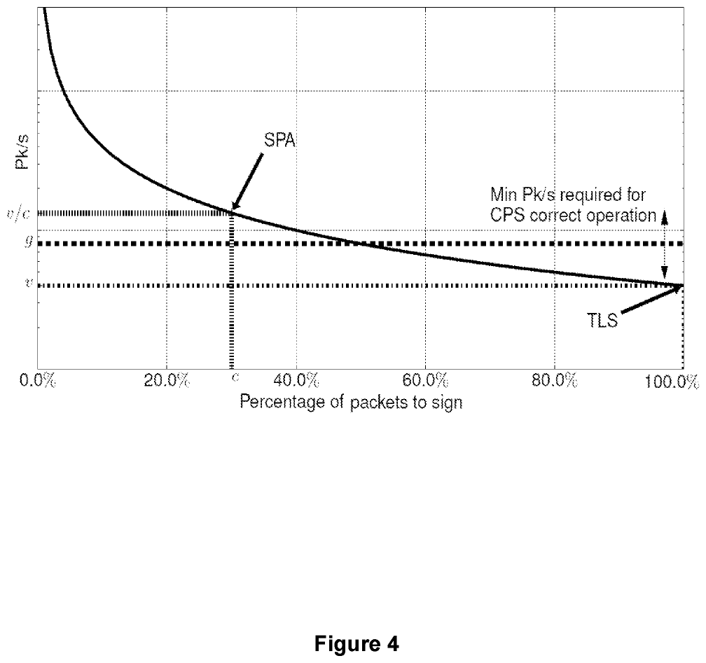

The performance of SPA vs. TLS will now be discussed with reference to FIG. 4. For simplicity, both TCP packets and ENIP packets are taken to be about the same size. FIG. 4 is a graph illustrating the relationship of the tolerance of a communication system with respect to the percentage of packets that need to be signed. The y-axis represents the tolerance of the system in packets per second while the x-axis represents the percentage of packets that need to be signed. Intuitively, the graph shows that the larger the percentage of network packets that need to be signed, the lower the tolerance of the system. With regard to the SPA protocol, let the speed in packets per second that a given cryptographic signature can provide for a given average packet size be ‘v’. Let the percentage of network packets that are critical packets 1000 i.e. percentage of network packets that need to be signed, be ‘c’. Then the actual throughput on the total generated packets g can be higher, since only ‘c g’ packets need to be signed. Therefore, the tolerance on the generated packets ‘g’ is effectively increased by a factor of ‘c’, allowing a maximum of v/c packets per second to be tolerated by the system.

Advantages

The proposed communication method 100 is easy to implement and to integrate into legacy systems by means of an external component. Moreover, it gives fine-granularity detection capabilities, since it can be pointed out which packet was altered in transit with almost instantaneous detection times. Additionally, by using the extension capabilities of ENIP, the communication method 100 is backwards compatible with devices that do not implement a verification module 120.

ICS often integrate several generations of devices that cannot easily be replaced or updated. As a result, a number of legacy industrial protocols are established that are widely supported by devices, but do not feature any security capabilities by design. In general, such protocols allow the reading of distinct memory locations (e.g., in Modbus/TCP) or tags (in EtherNet/IP) that represent sensor values or similar. However, a general upgrade of all such devices in an ICS is too costly. Additionally, use of TLS tunnels to transmit data would not only incur computational overhead, but could also fail to pass through industrial network appliances or intermediate gateways.

As the authentication data is embedded as additional payload in the existing industrial protocols, similar to additional tags that are transmitted, receivers that are not aware of the authentication scheme would process the normal payload without benefitting from the authentication data. Intermediate devices that are unaware of the authentication scheme would also just pass along the authentication data as normal payload. As a result, the present disclosure integrates into legacy system smoothly.

Extension of SPA Protocol

In some scenarios, the underlying hardware is not as fast as desired. For example, when the processing speed is so slow that the number of packets being signed s(Δ) is greater than the number of packets being generated/captured g(Δ) as previously discussed; or when even faster hardware might be insufficient for stronger signature algorithms that are more computationally expensive.

There are benefits to having an even more efficient communication method. In particular, stronger signature algorithms are used with less concern for computational expense. For example, the use of public/private keys in asymmetric cryptography allows dynamic addition of new devices to the system if centrally signed certificates are used. In addition, the compromise of a single device will only expose a single private key, instead of exposing a secret key shared between many devices.

The follow section discusses an exemplary communication method 500 which is an extension of the SPA protocol of the previous section.

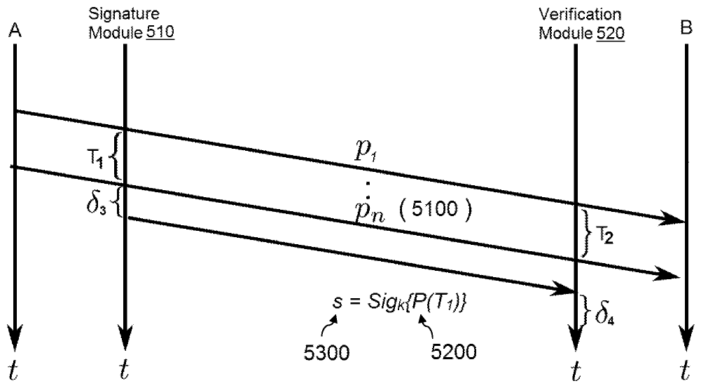

FIG. 5 is a timing diagram for an exemplary communication method 500 being implemented in an industrial control system. In the communication method 500, network packets are being communicated from a node A to a node B in the ICS.

It is useful to denote the following terms first.
P(T₁) sequence of outgoing packets in the time interval T₁
[E[|P(T₁)|] expected number of packets in time interval T₁ wherein [E[|P(T₁)|]=n such that the typical set is P(T₁)={p₁, . . . , pₙ}

In the communication method 500, network packets carrying respective payloads are received by the signature module 510. The signature module 510 forwards the network packets 5100 through the communication network, in addition to accumulating a copy of their associated payloads in a queue within a time interval of T₁. After time T₁ has passed, there would be an aggregated signature packet P(T₁) 5200 having an aggregate of payloads accumulated in the signature queue. The signature module 510 generates one aggregated signature 5300 [s=Sigₖ{P(T₁)}] for the entire sequence of network packets. Calculating the signature similarly incurs a delay δ₃ as shown in the timing diagram. The signature module 510 then transmits the aggregated signature 5300 forward through the communication network at time T₁+δ₃ after the first associated payload p₁ is accumulated in the signature queue. Additionally, the sequence number of the first and the last element of the queue are appended to the aggregated signature 5300 for identification purposes.

At the receiving end, a verification module 520 receives the network packets 5100 carrying respective payloads. The verification module 520 forwards the network packets 5100 to node B without verification, in addition to accumulating the network packets in a verification queue. After time T₂ has passed, there would be an aggregated verification packet having an aggregate of payloads associated with the network packets accumulated in the verification queue. The aggregated verification packet is stored in the verification queue until the aggregated signature 5300 is received by the verification module 520. Once the aggregated signature 5300 has been received, a verification process then verifies the integrity of the network packets 5100 by authenticating the aggregated signature 5300 in a similar manner as the verification process of communication method 100. Necessarily, the verification process introduces a delay δ₄ as shown in the timing diagram.

While the communication method 500 is described with reference to the communication system as a whole, the communication method 500 can similarly be viewed from the perspective of two separate modules: the signature module 510 and the verification module 520.

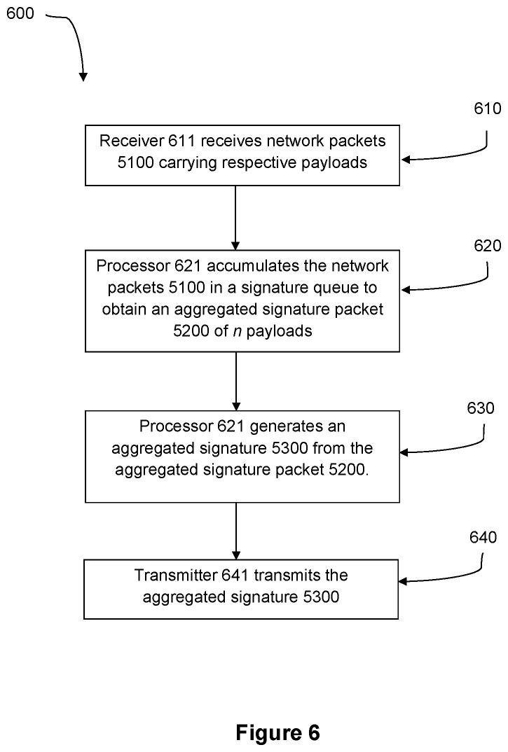

FIG. 6 is a flow diagram illustrating an exemplary communication method 600 from the perspective of the signature module 510.

At a step 610, a receiver 611 of the signature module 510 receives network packets 5100 carrying respective payloads that are being sent to an address in the ICS.

At a step 620, a processor 621 of the signature module 510 accumulates the network packets 5100 in a signature queue of the signature module 510. In particular, the payloads associated with the respective network packets are accumulated such that after a time period T₁, the processor 621 obtains an aggregated signature packet 5200 of n payloads that have been accumulated in the signature queue.

In the present embodiment, it is understood that the signature module 510 is listening to the network all the time for network packets. The network packets are being received at the signature module 510 and subsequently transmitted along the communication network. By accumulating network packets in a signature queue, the network packet or the associated payload accumulated in the signature queue is a copy of the received network packet. In an alternative embodiment, it is possible that the signature module 510 holds the network packet in which case step 620 may include an additional step of transmitting the network packets unsigned to the intended address.

In addition, in the present embodiment, the signature module 510 does not distinguish between network packets that carry critical payloads 1000 and non-critical payloads 1100. However, in an alternative embodiment, it is possible for the signature module 510 to distinguish between the two types of payloads and accumulate only critical payloads 1000 in the signature queue, in which case step 620 may also include an additional step of selectively capturing critical network packets 1000 which are identified based on a predefined list of critical payloads capable of controlling a physical state of the ICS.

At a step 630, the processor 621 generates an aggregated signature 5300 from the aggregated signature packet 5200 using a signing algorithm. The signing algorithm can be either a symmetric or an asymmetric signature algorithm.

At a step 640, a transmitter 641 of the signature module 510 then sends the aggregated signature 5300 to the intended destination in the ICS.

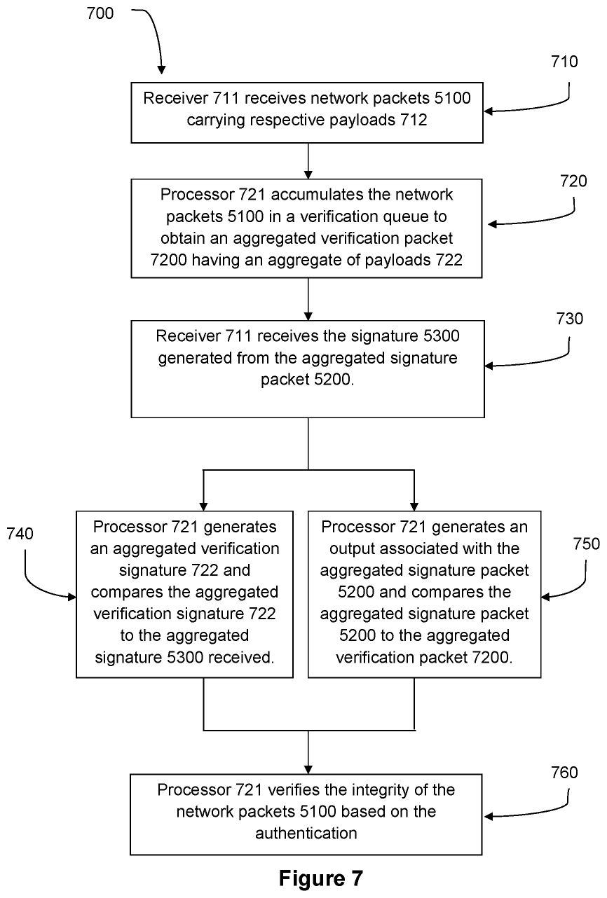

FIG. 7 is a flow diagram illustrating an exemplary communication method 700 from the perspective of the verification module 520.

At a step 710, a receiver 711 of the verification module 520 receives the network packets 5100 that are carrying respective payloads 712.

At a step 720, a processor 721 of the verification module 520 accumulates the network packets 5100 in a verification queue of the verification module 520. In particular, the payloads 712 associated with the respective network packets 5100 are accumulated such that after a time period T, the processor 721 obtains an aggregated verification packet 7200 of n payloads 722 that have been accumulated in the verification queue.

At a step 730, the receiver 711 further receives the aggregated signature 5300 generated from the aggregated signature packet 5200 using the signing algorithm.

At a step 740 or 750, the processor 721 of the verification module 520 authenticates the aggregated signature 5300 to verify the integrity of the network packets 5100. As is the case with communication method 100, the way that the aggregated signature 5300 is authenticated depends on the signature algorithm that is used to generate the aggregated signature 5300. For symmetric signature algorithm, at step 740, an aggregated verification signature 722 is computed/generated from the aggregated verification packet 7200 using the verification algorithm and compared to the aggregated signature 5300 received. For asymmetric signature algorithm, at step 750, an output related to the aggregated signature packet 5200 is generated from the aggregated signature 5300 received using the verification algorithm and compared to the aggregated verification packet 7200. In particular, the output is a hash (summary) of the aggregated signature packet 5200.

At a step 760, the processor 721 verifies the integrity of the network packets 5100 based on the results of the previous steps. For step 740, the network packets 5100 received have not been manipulated if the aggregated verification signature 722 matches the aggregated signature 5300 received. For step 750, the network packets 5100 received have not been manipulated if the output matches the hash of the aggregated signature packet 5200 obtained from accumulating the network packets 5100 in a signature queue of the signature module 510.

If there is a mismatch, the processor 721 raises an alarm to alert the system/user of an attack.

For simplicity, communication methods 500, 600, 700 are collectively termed Aggregated Selective Packet Authentication (ASPA) hereinafter.

The ASPA protocol relies on lower layers i.e. TCP to ensure that no message gets lost during transmission. That will ensure that the verification module 520 and signature module 510 always have the same view of exchanged messages. The premise behind ASPA is that authenticated signature schemes are relatively inefficient for short amount of data but they get more efficient for large amounts of data. Thus on average it is usually faster to perform an aggregate signature over multiple packets instead of signing them individually and as a result the aggregate signature increases the signing rate s.

Performance Evaluation of ASPA

In the case of symmetric authentication, let δ (size, cpu, alg) be the time needed to sign a packet of size ‘size’ with algorithm ‘a/g’ on CPU ‘cpu’. The signature scheme is typically based on HMAC and an underlying hash function (such as SHA-256). In that case, there is a constant ‘b’ such that δ (b′, cpu, alg)≈δ (b, cpu, alg) for b′≤b. However, for

$$B > b \text{:} δ ( B , cpu , alg ) = δ ( b , cpu , alg ) + ⌈ \frac{B - b}{b} ⌉ \cdot c$$

where c<δ (b, cpu, alg). Therefore, given an expected packet number of a certain expected size, it is more efficient to sign multiple packets instead of just one, in terms of the rate per interval ‘s’.

In the case of signatures based on asymmetric cryptography (such as ECDSA), typically the payload is first hashed and then an operation involving the private key is performed on the digest (such as decryption). Since the cryptographic operation is orders of magnitude slower than the hashing operation, signing multiple packets takes almost as long as signing a single packet.

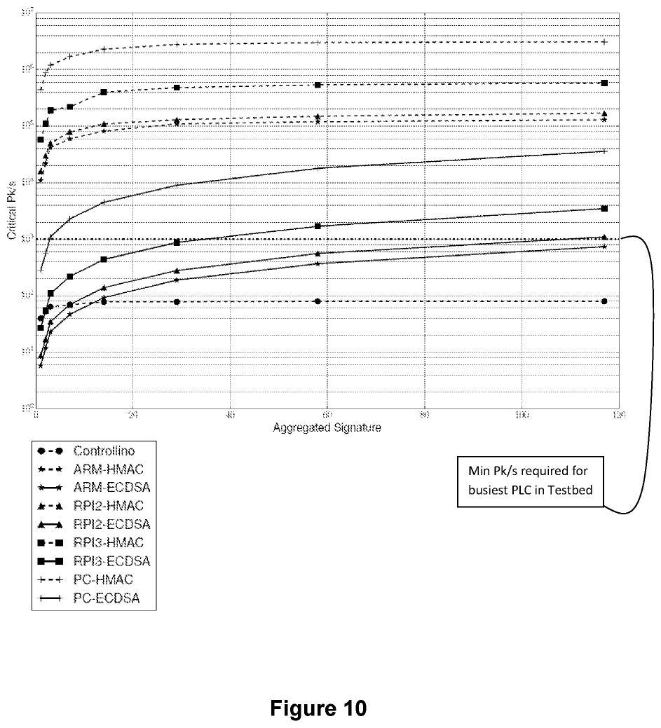

The above described effects on the signing rate ‘s’ are observed in the plotted values of FIG. 10 for symmetric and asymmetric algorithms and different values of ‘n’.

In practice, a device can have active connections (TCP streams) to ‘m’ devices at the same time. As a result, there will be ‘m’ queues Q^{S}_{Δ,i}, possibly signed with different keys. In that case, the constraint becomes ∀ᵢ gᵢ<sᵢ, where g=Σᵢ₌₁^{m}gᵢ. In the case of ICS, devices typically communicate only with one or two devices (e.g. m=2). For simplicity, a single queue is assumed for the following discussion.

ASPA Versus TLS

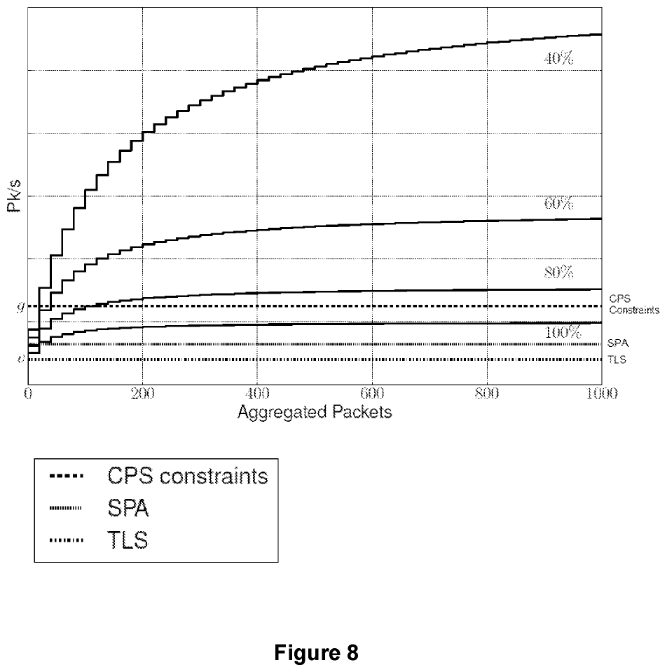

The performance of ASPA vs. TLS will now be discussed with reference to FIG. 8. For simplicity, CPU power and packet sizes are taken to be constant. In this scenario, only critical packets are selectively captured and accumulated in the queue for signing. FIG. 8 is a graph illustrating the relationship of the tolerance of a communication system with respect to the size of the aggregated packets 5200 for different percentages of network packets 5100 that are captured i.e. critical. Notably, in the case where 100% of the network packets 5100 are critical, the case represents the general case where all network packets 5100 are aggregated. The x-axis represents the size of aggregated packets 5200 to be authenticated while the y-axis represents the tolerance of the system in terms of packets per second. The step functions show performance achieved by signing different percentages of network packets 5100 that are captured.

$$Let v = \frac{1}{δ} ,$$

the number of packets per second an ideal implementation of TLS could sign. By using ASPA to aggregate n packets, the tolerance is approximately

$${v}^{1} = \frac{n}{δ + ( n - 1 ) \cdot {δ}^{1}}$$

packets per second which is faster than v, and notably converges to a constant since

$${lim}_{n \to ∞} \frac{n}{δ ( n - 1 ) \cdot {δ}^{1}} = \frac{1}{{δ}^{1}} .$$

To give an example, let ‘p’=‘r’ be 1000 packets per second. Let ‘s’=‘v’ be 300 packets per second. In that case, cryptography-enabled authentication causes backlogs since ‘g’+‘r’=2000>‘s’+‘v’=600. By implementing the ASPA protocol with ‘n’=50 packets for ‘T’ ≈30 ms, ‘s’ is augmented to about 1.5×10⁴ packets per second which implies a minimum reaction time to attacks of about 60 ms.

Advantages

The ASPA protocol is useful in situations where signing each packet individually is not feasible due to slow hardware or constraints of the ICS network. In particular, it offers a significant advantage when signing multiple packets with ECC based authentication. The ASPA protocol can be used selectively for only critical message (as in the SPA protocol). Alternatively, it could be used to provide delayed authentication for all messages, as the amount of data included in the aggregated signature 5300 has a negligible impact on the overall time of creating the signature.

It should be noted that an attack can only be detected after ‘T’ time has passed and an invalid signature is received since it requires at least that much time for the network packets 5100 to be accumulated and transmitted. The course granularity of the authentication could potentially delay reaction times to attacks depending on the size ‘T’ of the signing window. However, in most signing algorithms/hardware, the ideal window for authentication consists of a few dozens of packets. As such, ‘T’ is relatively small compared to the interaction time with the system that is required by attackers in order to influence physical states of the system. Reaction time to attacks on the system is therefore sufficiently fast in practice to prevent most attackers from changing a physical state of the system.

Evaluation

A Water Treatment Testbed (an exemplary industrial control system) is used to evaluate the performance of the SPA and ASPA protocols described against the real-time constraints of the water treatment testbed.

Water Treatment Testbed

Typically, a Water Treatment Testbed in an ICS with a six stage process. In a nutshell, the process begins by collecting the incoming water in a tank, the collected water then undergoes a chemical treatment stage, and the treated water is then filtered through an Ultrafiltration (UF) system. After the Ultrafiltration stage, the water is de-chlorinated using a combination of chemicals and Ultraviolet lamps, and then fed to a Reverse Osmosis (RO) stage. Finally, a backwash process cleans the membranes in the UF using the water produced by RO.

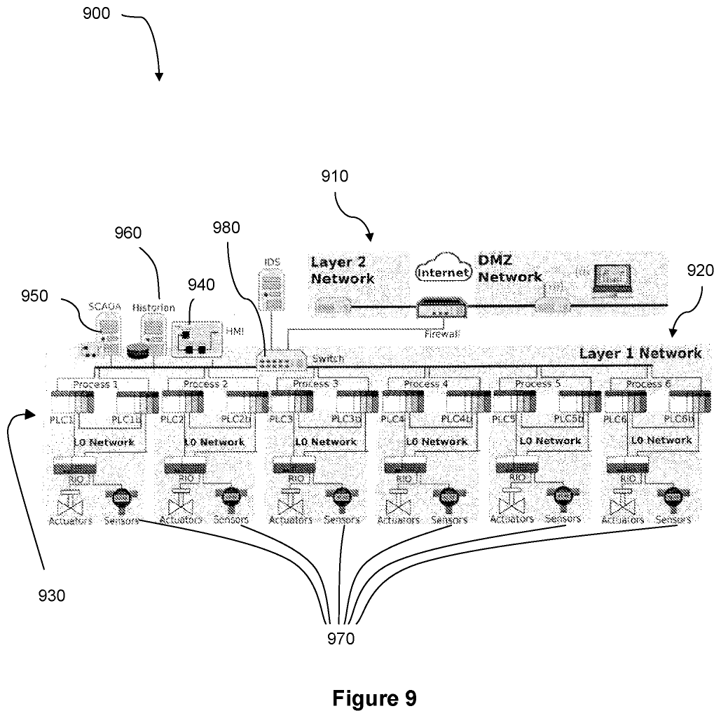

FIG. 9 illustrates an exemplary Water Treatment Testbed network architecture 900. The network architecture comprises a layered communications network 910, 920, PLCs 930, HMIs 940, SCADA system 950, and a Historian 960. Data from sensors 970 are available to the SCADA system 950 and recorded by the Historian 960 for subsequent analysis.

The evaluation is focused on benchmarking integrity, and authenticity controls in the plant network that connects the PLCS 930, HMI 940 and SCADA system 950. The network 910, 920 uses the ENIP industrial protocol on top of an (Ethernet-based) TCP/IP network. Network captures are performed by setting up a mirroring port on the plant network industrial switch 980. From those captures, ENIP-CIP communications among twenty-one hosts are identified through implicit and explicit messages.

Implicit messages (UDP/2222) are used in the plant for keep-alive signals, while explicit messages (TCP/44818) are used for configuring, monitoring and controlling the plant stages. On average, the plant communications at a rate of 16000 ENIP-CIP messages per second over all stages. About 14.3% of ENIP-CIP connections are UDP/2222 and the rest of the 85.7% are TCP/44818. TCP connections can be further split into TCP session traffic (42.7%) and CIP explicit messages (42.9%).

Among the CIP explicit messages, a subset of CIP services that deals with critical data/payload 1000 is extracted as manipulation of those services could affect the state of the controlled physical process. The following services are considered critical: Read Data (Service 0x4C); Write Data (Service 0x4D); Read Tag Fragmented Data (Service 0x52).

CIP services are classified as critical data/payload 1000 since an attacker might raise a fake alarm in the SCADA system 950 or he might hide a safety-related event modifying its data on the fly. The Write Data CIP service is classified as critical payload 1000 because an attacker might directly modify the behaviour of actuators pushing data into PLCs 930. By selecting CIP services with critical payload 1000, only 42% of traffic generated by the Water Treatment Testbed (including TCP and UDP) are being signed, thereby avoiding processing and bandwidth overheads for non-critical data/payload CIP services (e.g. get all attributes service).

Table 1 summarizes the frequency and size of critical packets 1000 that are sent and received by PLC2 in the Water Treatment Testbed. PLC2 is chosen to represent an upper bound because it is the busiest device in the testbed.

TABLE 1
Frequency and size of critical packets
1000 shared by host PLC2 to others.

| | | Sent | Received |
|---|---|---|---|
| ENIP Message | Request | 561 Pk/s | 607 Pk/s |
| | | μ = 63 B, σ = 3.36 | μ = 69 B σ = 5.32 |
| | Response | 566 Pk/s | 561 Pk/s |
| | | μ = 75 B, σ = 58.16 | μ = 86 B σ = 9.42 |

| | | |
|---|---|---|
| Total Pk/s | 1127 | 1168 |

As indicated in Table 1, PLC2 sends 1127 packets per second on average and receives 1168 packets per second on average. The average size per packet is 73 Bytes.

Hardware Benchmark

The packet signing rate s(t, cpu, alg) and efficiency of the underlying primitives is evaluated using different types of hardware platforms. The following hardware is used:

Controllino Controllino is an open source Hardware PLC, based on Arduino Mega 2560 board, with an ATmega2560 CPU (16 MHz), 256 KB of flash memory, an Ethernet connector, and two serial interfaces. Spaniakos cryptographic library is used in this evaluation.

ARM To replicate ARM chips that are used in the testbed, QEMU emulator is set up with the following settings: ARM926EJ-S rev 5 processors family at 530 MHz, 256 MB of RAM, Debian 3.2.51 32 bit Operating System, and the libgcrypt-1.6.5 cryptographic library.

Raspberry Pi Raspberry Pi is a single-board computer of credit card-size. It is a popular multipurpose hardware because of its low energy consumption and low cost. It is the chosen hardware to implement the authentication and integrity mechanism. The characteristics of the Raspberry Pi model 2 (RPi2) are: Quad-core ARM Cortex-A7 processor at 900 MHz, 1 GB of RAM, 4 USB ports, 40 GPIO pins and an Ethernet port. The cryptographic library used was again libgcrypt-1.6.5.

PC A PC workstation configured with the following specifications: Intel Core i5-5300U processor at 2.30 GHz, 3 GB of RAM, Xubuntu 15.10 64 bit OS, and libgcrypt-1.6.5 as cryptographic library.

In addition to benchmarking HMAC-SHA256 signature process, the elliptic curve digital signature algorithm (ECDSA) signature process is also benchmarked against the 5 hardware listed above. Table 2 shows the time in μs to sign different packet sizes over 5 types of hardware (rounded values). Table 3 shows the average signing rate in packets/sec for different packet sizes over 5 types of hardware.

TABLE 2
Benchmark of HMAC-SHA256 and ECDSA signature process timing
for different packet sizes over 5 types of hardware.

| | | HMAC - Time | | | | |
|---|---|---|---|---|---|---|
| Size | | Controllino | ARM | RP12 | RP13 | PC |
| 64 | B | 2.2 · 10⁴ | 76 | 53 | 15 | 2 |
| 128 | B | 3.3 · 10⁴ | 78 | 58 | 16 | 2 |
| 256 | B | 5.5 · 10⁴ | 84 | 69 | 18 | 3 |
| 512 | B | 1 · 10⁵ | 117 | 89 | 32 | 4 |
| 1 | KB | 1.8 · 10⁵ | 171 | 130 | 35 | 6 |
| 2 | KB | 3.6 · 10⁵ | 252 | 211 | 58 | 10 |
| 4 | KB | 7 · 10⁵ | 474 | 374 | 104 | 18 |
| | | ECDSA - Time | | | | |
| 4 | KB | N/A | 1.5 · 10⁵ | 1 · 10⁵ | 3.2 · 10⁴ | 3.1 · 10³ |

TABLE 3
Benchmark of HMAC SHA256 and ECDSA signing rate for
different packet sizes over 5 types of hardware

| | | HMAC - Average Pkt/s | | | | |
|---|---|---|---|---|---|---|
| Size | | Contr. | ARM | RP12 | RP13 | PC |
| 64 | B | 40 | 1.1 · 10⁴ | 1.6 · 10⁴ | 5.8 · 10⁴ | 4.4 · 10⁴ |
| 128 | B | 53 | 2.2 · 10⁴ | 3 · 10⁴ | 1.1 · 10⁵ | 8.8 · 10⁴ |
| 256 | B | 64 | 4.2 · 10⁴ | 5 · 10⁴ | 1.9 · 10⁵ | 1.2 · 10⁴ |
| 512 | KB | 70 | 6 · 10⁴ | 7.9 · 10⁴ | 2.2 · 10⁵ | 1.7 · 10⁴ |
| 1 | KB | 78 | 8.2 · 10⁴ | 1.1 · 10⁴ | 4 · 10⁵ | 2.3 · 10⁴ |
| 2 | KB | 78 | 1.1 · 10⁵ | 1.3 · 10⁴ | 4.8 · 10⁵ | 2.8 · 10⁴ |
| 4 | KB | 80 | 1.2 · 10⁵ | 1.5 · 10⁴ | 5.4 · 10⁵ | 3 · 10⁴ |
| | | ECDSA - Average Pkt/s | | | | |
| 4 | KB | N/A | 3.7 · 10² | 5.6 · 10² | 1.7 · 10⁴ | 1.8 · 10⁴ |

In the case of elliptic curve cryptography (ECC) using ECDSA, the cryptographic operation dominates the execution time of the hashing component of the signing algorithm such that the times for signing payloads of up to 4 KB are almost identical to those of small payloads of 32B. The results for payloads on the 4 KB range are reported in the last row of Table 2. The resulting s for ASPA for aggregated signatures of about 58 packets (4 KB) is reported in Table 3.

Discussion

A summary of the empirical results using different hardware platforms and cryptographic algorithms combinations over the Water Treatment Testbed is disclosed.

A comparison of the performance of SPA protocol (first two columns respectively) versus ASPA protocol is shown in Table 4 for n=58 packets.

The results confirm that with a processor such as the one in Controllino (16 MHz), it is not feasible to cope with real time requirements of the Water Treatment Testbed networks for all algorithm considered.

TABLE 4
Feasibility of algorithms vs. hardware in the Water Treatment Testbed

| | Sequential | | | | Parallel | | | |
|---|---|---|---|---|---|---|---|---|
| | HMAC | ECC | HMAC-ASPA | ECC-ASPA | HMAC | ECC | HMAC-ASPA | ECC-ASPA |
| Controllino | X | X | X | X | X | X | X | X |
| ARM | ✓ | X | ✓ | X | ✓ | X | ✓ | X |
| RPi2 | ✓ | X | ✓ | ✓ | ✓ | X | ✓ | ✓ |
| RPi3 | ✓ | X | ✓ | ✓ | ✓ | X | ✓ | ✓ |
| PC | ✓ | X | ✓ | ✓ | ✓ | X | ✓ | ✓ |

FIG. 10 is a graph of the ASPA performance on different hardware. From FIG. 10, it is confirmed that symmetric signatures are supported by most hardware while ECC signatures are possible for certain hardware with better processing power such as Raspberry Pi2, Pi3 and PCs.

From a communications cost perspective, a signature in HMAC would add an overhead of 28% in size for an average ENIP packet, while ECDSA would add about 57%. If only critical packets 1000 are signed, which corresponds to 42% of total traffic, the overhead in bandwidth will only be 12% and 24% for HMAC and ECDSA respectively.

The present disclosure is also tested in a link between two PLCs of a Water Treatment Testbed using Raspberry Pi3. Details are provided in the following section.

Authenticated link using Raspberry Pi A link between two PLCs 930 in the Water Treatment Testbed is chosen to perform the test. The devices are configured as Ethernet bridges and placed as physical Men-in-the-Middle over the link.

Once connected, the devices passively listen to packets from and to the PLC 930 and SCADA 950. When a critical-data packet is identified, it is captured and the ENIP payload is signed with HMAC-SHA256 algorithm using a pre-shared key. The concatenation of the captured packet and its signature is injected back into the communication channel.

Similarly, the remote Raspberry Pi3 is placed as a verification module 520 in front of the destination PLC 930. Once the verification module 520 identifies a packet coming from its counterpart, the packet is analysed looking for an attached signature, the signature is extracted and verified against the ENIP payload using HMAC-SHA256 algorithm with the pre-shared key. The packet is converted back to its original version and is delivered to its destination.

Four additional tags (variables) are configured in the tested PLCs 930 to store information about signing and verification processes. The four variables are described as follows: Signed messages: Number of signed messages by its cryptographic module; Checked messages: Number of signed message correctly verified by its cryptographic module; Wrong-signature messages: Number of signed messages which signature does not correspond to its payload detected by its cryptographic module; No signed messages: Messages with critical data/payload 1000 from a peered host with no-attached signature detected by its cryptographic module.

Every Raspberry Pi3 writes this data on its featured PLC variables to control the whole process. A SCADA system 950 could monitor these variable values and could trigger an alarm in case of an integrity violation.

Although the present disclosure has been described with reference to specific exemplary embodiments, various modifications may be made to the embodiments without departing from the scope of the invention as laid out in the claims.

For example, in the present disclosure, ENIP is used as an example protocol merely as a descriptive aid. Different industrial protocols have been used in ICS. They evolved from serial communication networks (e.g, RS-485, RS-232) to bus systems (e.g., Fieldbus), and then to Ethernet-based communications such as EtherNet/IP (ENIP). ENIP is a modern, object-oriented application layer industrial protocol that implements the Common Industrial Protocol (CIP) specifications over the TCP/IP protocol stack. ENIP can be extended to support custom commands and device profiles, and it provides a native compatibility with traditional TCP/IP based IT corporate network. It should be clear that the present disclosure should not be limited to the ENIP protocol. In fact, as should be clear by now, the present disclosure does not depend on the underlying industrial protocol. A skilled person will be able to readily translate the present scheme to other modern industrial protocols such as Modbus TCP and PROFINET.

Furthermore, although a Water Treatment Testbed, is used as an example with some hardware configurations, the possible configurations in practice may vary highly. For instance, in a full scale water plant, the number of sensors and actuators could be one order of magnitude higher (g=10⁴) whereas the available hardware could be something in the middle between the Controllino (16 MhZ) and the ARM processor (500 MhZ). Moreover, the underlying cryptographic algorithm could be more or less lightweight.

It should be clear that various embodiments as discussed above may be practiced with steps in a different order as disclosed in the description and illustrated in the Figures. Modifications and alternative constructions apparent to the skilled person are understood to be within the scope of the disclosure.

1. A communication method for an industrial control system (ICS), the method comprising the steps of:
receiving network packets that are being sent to an address in the ICS, the network packets carrying critical and non-critical payloads;
selectively capturing a critical network packet, the critical network packet being identified based on a predefined list of critical payloads capable of controlling a physical state of the ICS;
generating a signature from the critical network packet using a signing algorithm; and
transmitting a combined network packet comprising the critical network packet and the signature to the address.

2. A communication method according to claim 1, wherein the critical payloads are generated from system services that deal with data read from sensors or actuators, and data written to actuators or registers of devices in the ICS.

3. A communication method according to claim 2, wherein the system services comprise Read Data, Write Data, and Read Tag Fragmented Data.

4. A communication method according to claim 1, further comprising embedding the signature as an additional payload in the combined network packet.

5. A communication method according to claim 1, further comprising embedding a timestamp or a counter to the combined network packet.

6. A communication method according to claim 1, wherein generating the signature is performed at a signing rate at least equal to a capture rate at which the critical network packet is being selectively captured.

7. A communication method according to claim 1, wherein the signing algorithm is a symmetric or an asymmetric signature algorithm.

8. A communication method for an Industrial Control System (ICS), the method comprising the steps of:
receiving a combined network packet comprising a critical network packet and a signature, the critical network packet being selectively captured from network packets carrying critical and non-critical payloads sent from an address in the ICS, and is identified based on a predefined list of critical payloads capable of controlling a physical state of the ICS, and the signature being generated from the critical network packet using a signing algorithm before being transmitted; and
verifying integrity of the critical network packet by authenticating the signature using a verification algorithm.

9. A communication method according to claim 8, wherein verifying the integrity of the critical network packet is performed at a verification rate at least equal to a receiving rate at which the combined network packet is being received.

10. A communication method according to claim 8, wherein the signing algorithm is a symmetric signature algorithm, the communication method further comprises authenticating the signature by generating a verification signature from the critical network packet using the verification algorithm, and comparing the verification signature to the signature received for a match.

11. A communication method according to claim 8, wherein the signing algorithm is an asymmetric signature algorithm, the communication method further comprises authenticating the signature by generating an output associated with the critical network packet from the signature received using the verification algorithm, and comparing the output to the critical network packet for a match.

12. A communication method according to claim 10, further comprising sounding an alarm when there is a mismatch.

13. A communication method for an industrial control system (ICS), the method comprising the steps of:
receiving network packets that are being sent to an address in the ICS, the network packets carrying critical and non-critical payloads;
selectively capturing a critical network packet, the critical network packet being identified based on a predefined list of critical payloads capable of controlling a physical state of the ICS;
generating a signature from the critical network packet using a signing algorithm;
transmitting a combined network packet comprising the critical network packet and the signature to the address;
receiving the combined network packet at the address; and
verifying integrity of the critical network packet by authenticating the signature using a verification algorithm.

14.-32. (canceled)
